(19) United States
(12) Patent Application Publication
(10) Pub. No.: US 2009/0054719 A1
(43) Pub. Date: Feb. 26, 2009

(54) SYSTEM AND METHOD FOR RECYCLING OF LEAD FROM LEAD-BASED PAINT WASTE

(76) Inventor: Dale M. Timmons, Issaquah, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/547,316

(22) PCT Filed: Mar. 31, 2005
(86) PCT No.: PCT/US2005/010891

§ 371 Date: Oct. 27, 2008

Related U.S. Application Data
(60) Provisional application No. 60/558,635, filed on Apr. 1, 2004.

(51) Int. Cl. B09B 3/00; B02C 23/00; F23G 7/00

(52) U.S. Cl. 588/412; 241/65; 241/68; 110/259; 110/203

(57) ABSTRACT

A transportable process for the oxidation of deconstruction and demolition debris contaminated with lead-based paint that includes sizing and heating waste for a predetermined period of time and at a temperature in the range of 500° to 1,200° C. The process results in concentration of the lead in a small volume of product possessing physical and chemical properties that promotes recycling of the lead rather than disposal of the lead in landfills.

### BACKGROUND OF THE INVENTION

1. Field of the Invention

The present invention relates to the recycling of lead and, more particularly, to a process of concentrating lead from hazardous waste that is contaminated with lead-based paint and to an apparatus and system for performing the method.

2. Description of the Related Art

Lead is a highly toxic metal that was used for many years in a wide variety of consumer products. Lead can cause a range of adverse health effects, from behavioral problems and learning disabilities to seizures and death. Children 6 years old and younger are most at risk because their bodies are growing quickly.

Research suggests that the primary sources of lead exposure for most children are deteriorating lead-based paint, lead contaminated dust, and lead contaminated residential soil.

The U.S. Environmental Protection Agency (EPA) has played a major role in addressing these residential lead hazards. In 1978, there were nearly three to four million children with elevated blood lead levels in the United States. In the 1990s, that number had dropped to 434,000 children, and it continues to decline.

Since the 1980's, the EPA and its federal partners have phased out lead in gasoline, reduced lead in drinking water, reduced lead in industrial air pollution, and banned or limited lead used in consumer products, including residential paint. States and municipalities have set up programs to identify and treat lead poisoned children and to rehabilitate deteriorated housing.

The Residential Lead-Based Paint Hazard Reduction Act (Title X) developed a comprehensive federal strategy for reducing lead paint hazard exposure and provided the authority for further regulations by amending the Toxic Substances and Control Act (TSCA) to include Title IV (Lead Exposure Reduction). These other regulations include the National Lead Laboratory Accreditation Program (405(b)), which establishes protocols, criteria, and minimum performance standards for laboratory analysis of lead in paint, dust, and soil, and the Hazard Standards for Lead in Paint, Dust, and Soil (403), which establishes standards for lead-based paint hazards and lead dust cleanup levels in most pre-1978 housing and child-occupied facilities.

On Dec. 18, 1998, the EPA issued Proposed Rules that would relax disposal requirements for waste derived from households in an effort to make it more affordable for citizens to dispose of this waste from renovations and other home improvements. Concurrently, it was proposed to change the manner under which Lead-Based Paint (LBP) waste is regulated by managing it under the Toxic Substances Control Act (TSCA) instead of Resource Conservation Recovery Act (RCRA). These proposed changes appear in the Federal Register at Vol. 63, No. 243.

In response to the Congressional directive in the RCRA section 3001(a), the EPA adopted a two-part definition for identified or listed “hazardous wastes” (45 FR 33084, May 19, 1980). First, the EPA published lists of specific hazardous wastes, in which EPA described the wastes and assigned a “waste code” to each of them (40 CFR part 261, subpart D). These wastes are known as “listed” hazardous wastes. Second, the Agency identified four characteristics of hazardous waste that are subject to objective measurement: ignitability, corrosivity, reactivity, and toxicity (see 45 FR 33121-22, May 19, 1980). Any solid waste exhibiting one or more of these characteristics is a “characteristic hazardous waste” subject to regulation under RCRA Subtitle C (see 40 CFR parts 262, 264 to 268, and 270). To measure objectively the characteristic of “toxicity” under RCRA Subtitle C, the EPA established the Toxicity Characteristic Leaching Procedure (TCLP) test as part of the Toxicity Characteristic (TC) rule. (55 FR 11798, Mar. 29, 1990). Under the TC rule, a waste may be a hazardous waste if any chemicals identified in the rule, such as lead, are present in leachate from the waste (generated from use of the TCLP) at or above the specified regulatory levels (40 CFR 261.24). Under the TC rule; generators of solid waste must either use their knowledge of the waste or perform the TCLP test using a representative sample of the waste “as generated” to determine if the waste exhibits a toxicity characteristic. The regulatory level for lead in the waste extract (i.e., leachate) is 5 milligrams per liter (mg/L). If the leachate of waste contains lead at this level or higher, then the waste is a “characteristic” hazardous waste, and the generator must comply with the applicable RCRA Subtitle C requirements in 40 CFR parts 262 through 266, 268, and 270.

Certain wastes derived from demolition of structures that have been painted with LBP typically fail the TCLP test and are thus regulated as RCRA characteristic hazardous waste. This waste is bulky and expensive to dispose of because it takes up an inordinate amount of landfill volume. In addition, landfill disposal does nothing to reduce the toxicity of the lead. As the waste in landfills decomposes, there is potential for accelerated release of lead from the waste.

Hazardous waste incinerators can burn the LBP waste, and this is an accepted method for treating this waste even though burning does not destroy lead. Hazardous waste incinerators typically burn a wide variety of wastes and the quantity of LBP waste is relatively small compared to the overall waste load. Also, the cost of hazardous waste incineration typically far exceeds that of landfilling so incineration of LBP is not widely practiced. The lead from the incinerated LBP ends up in the ash from the incinerator. This ash is either landfilled or stabilized and then landfilled. In either case, the lead still ends up in landfills.

Lead is highly toxic and LBP is prevalent in a great many older buildings. There are increasing volumes of LBP waste that are being disposed of in landfills and much of it is coming from households and private citizens. There is growing concern regarding the expense of landfilling this waste in hazardous waste landfills, and Regulators have proposed a relaxation of these rules in the Federal Register at Vol. 63, No. 243, Friday, Dec. 18, 1998, simply because there do not appear to be any viable options. Also, high disposal costs of this type of waste have historically resulted in “midnight dumping” because people cannot afford to dispose of the waste properly. Hence, regulators strongly support alternative methods of disposal and recycling. Because of these factors, there is an urgent need for an environmentally-responsible, economic alternative to the current practice of landfilling LBP waste.

### BRIEF SUMMARY OF THE INVENTION

Accordingly, the disclosed embodiment of the present invention provides a process wherein lead derived from LBP waste can be concentrated into a small volume of treated product. Further, the product produced by the process possesses physical and chemical properties suitable for re-processing as lead ore in a lead smelter or other reprocessing facility suitable for extracting and reusing the lead. In addition, the process recycles the lead in a manner that conforms to environmental laws and regulations.

In accordance with one embodiment of the present invention, a process is provided that includes oxidizing LBP waste, reducing its volume by up to 97%, attaining concentrations of lead oxide in the treated residue of up to 25% with physical and chemical properties that facilitate recycling of the lead.

In accordance with another aspect of the invention, the process includes heating the waste to a temperature in the range of 500° C. to 1,200° C. Ideally, the waste is reduced to a particular size prior to heating.

In accordance with another embodiment of the invention, a process is provided for the recycling of lead from lead-based paint waste, the process including heating the lead-based paint waste for a predetermined period of time in an oxidizing environment in a predetermined temperature range to oxidize substantially all of the carbon in the lead-based paint waste, and to reduce the mass and volume of the lead-based paint waste for concentrating the lead in the remaining treated product.

A system for recycling lead is also provided, the system including a thermal treatment unit for heating lead-based paint waste to oxidize substantially all of the carbon in the waste and reduce the volume and mass for concentrating the lead in the remaining treated product.

In accordance with another embodiment of the invention, a system for processing lead-based paint waste to recycle the lead therefrom is provided, the system including a unit for reducing the size of the lead-based paint waste; a thermal treatment unit configured to oxidize substantially all of the carbon in the lead-based paint waste, to reduce the volume and mass of the lead-based paint waste to form a treated product in which the lead is concentrated; a discharge unit for collecting the treated product; and an exhaust treatment unit for treating and recycling exhaust from the thermal treatment unit for use in preheating air for the thermal treatment unit.

### BRIEF DESCRIPTION OF THE DRAWINGS

The foregoing and other features of the present invention will be more readily appreciated as the same become better understood from the following detailed description when taken in conjunction with the accompanying drawings, wherein:

FIG. 1 is a flow chart illustrating a process of the present invention; and

FIG. 2 is a block diagram illustrating a system formed in accordance with the present invention.

### DETAILED DESCRIPTION OF THE INVENTION

Buildings that predate the mid-1970s were commonly painted repeatedly with lead-based paint. When such buildings are demolished, significant portions of the building materials fail the EPA's TCLP test and are thus characteristic hazardous waste. The demolition debris that typically contains the most LBP includes exterior wood siding, window frames, sills and other pieces of trim but any painted surface potentially contains LBP that can leach lead into the environment.

Once the LBP waste has been removed from a structure, efforts can be made to remove the paint from usable wood surfaces and the uncontaminated portion of the wood recycled. While it is preferable to recycle usable wood, it is not always an economical alternative. The LBP waste (whether removed from the painted surfaces or not) can be treated directly with the process and system disclosed herein.

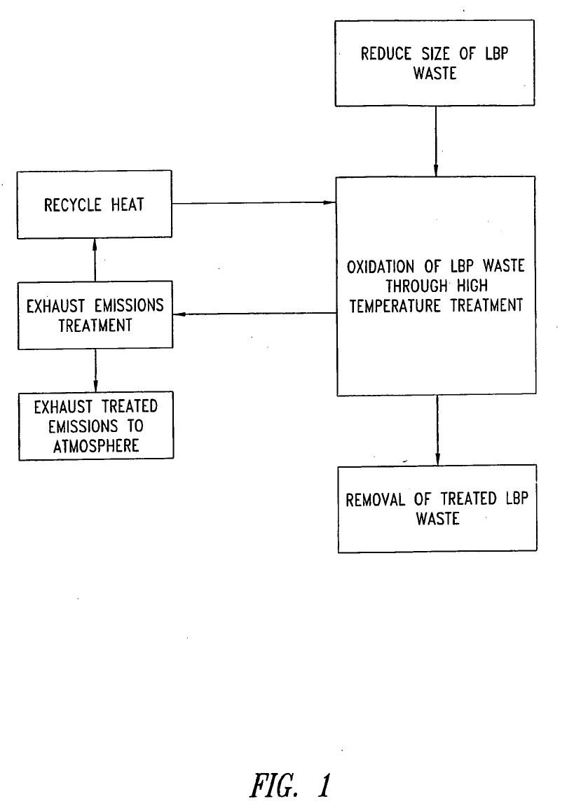

Referring initially to FIG. 1, shown therein is a flow chart illustrating a general overview of the process for treating LBP waste in accordance with the present invention. After the LBP waste is collected, it is first processed by shredding or grinding it to reduce particle sizes. Smaller particle sizes facilitate more rapid oxidation and more efficient operations. Preferably, the size range is less than two inches in diameter and preferably less than 1 inch in diameter. In addition, more rapid oxidation allows the BTU energy contained in the LBP waste to assist in sustaining thermal operations with minimal extra energy input.

Once the LBP waste has been shredded, it is continually fed into an oxidizing environment that exhibits sufficient airflow to oxidize all of the carbon contained in the waste while maintaining an atmosphere with little or no turbulence. It is necessary to minimize turbulence in the oxidizing environment because some of the particle sizes of the treated product are very small. The temperature at which the LBP waste is heated is sufficient to maintain rapid oxidation with relatively low production of nitrogen oxides while preventing volatilization of lead. A preferred range of temperatures is 500° C. to 1,200° C., depending on the type of waste, particle size, and the heating environment. For example, heating times in the range of 10 to 30 minutes are a preferred range for this embodiment of the invention. The heat treatment of the LBP waste must be carried out by providing a specific process temperature range with low air turbulence and in a highly oxidizing environment. The time-temperature relationship and method in which air is introduced to the system is important in its application to actual system design parameters.

For example the most suitable design for a particular LBP recycling system requires specification of a particular operation temperature range with a specific period of treatment and a specific rate of oxygen introduction. While ambient air may be used to provide the oxygen, the rate of introduction will depend on the particle size, in part to avoid blowing the particles to be treated off the treatment stage, and the quantity of air needs to be sufficient to oxidize all of the organic compounds (e.g. wood) present in the waste material within the preferred time range. Thus, the rate of air introduction would be higher for a shorter residence time and lower for a longer residence time. The design of the system for carrying out the process will allow for a variable rate of air introduction over a sufficiently wide range to achieve an optimum rate for each batch or processing cycle. Processing may take place in a batch or continuous treatment system that has been equipped with a negative pressure air treatment system.

The treated LBP waste is then collected and removed from the system for subsequent recycling. The treatment system generally should be equipped with an exhaust gas cooling system and particulate accumulation system. In addition, a system to control NOx emissions may be required depending upon local air emission regulations. Thermal processing systems may use direct or indirect methods of heating using fossil fuels, natural gas or other combustible gas mixtures, or may be electric heating elements. Such fuel usage will be substantially supplemented by the energy value of the LBP. Thus, another step in the process may involve recycling of heat from the exhaust to the heat treatment system as shown in FIG. 1.

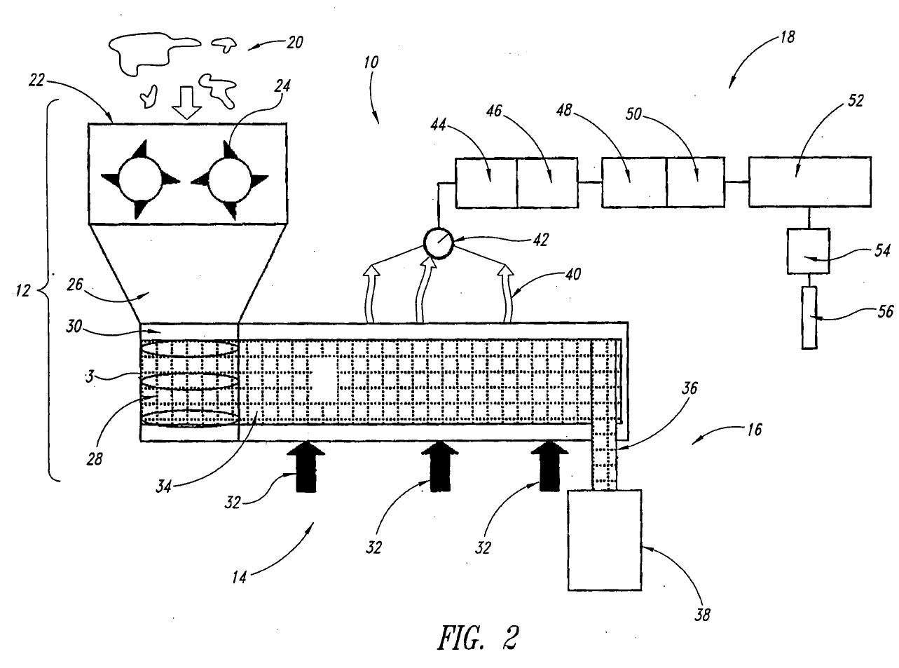

A representative system 10 used in carrying out the process of the present invention is illustrated in schematic form in FIG. 2.

As shown therein, the system 10 includes a size reduction unit 12 functioning as an input to a thermal treatment unit 14 having as an output a discharge unit 16. An exhaust treatment unit 18 is coupled to the thermal treatment unit 14 for treating and recycling heat energy.

The size reduction unit 12 is used to reduce the size of waste material 20 to enhance the treatment process as described above. Ideally, particle size is reduced to the range of less than two inches in diameter and preferably less than one inch in diameter.

Waste material 20 enters a shredder or grinder mechanism 22 that, for purposes of illustration, is shown as grinding wheels 24 that cooperate to crush or break up the waste material 20. It is to be understood that various devices are readily commercially available for accomplishing this process, and such will not be described in detail herein.

The feed material or LBP waste is then directed into a portable collection hopper and feed chute 26 that directs the reduced waste material into a waste feed distributor 28, where the prepared waste feed is distributed evenly into the thermal treatment unit 14. The feed chute 26 may be equipped with a suitable air lock, such as a roto-lock valve 30 that functions to isolate the waste while it is introduced and to prevent air from entering the thermal treatment unit at a rate that would produce unwanted turbulence in the thermal treatment unit.

The waste feed distributor 28 ensures consistent waste feed distribution into the thermal treatment unit 14. Heater air is introduced into a thermal processor 34 and is controlled by manifolds and valves 32, which are represented by the large dark arrows in FIG. 1.

Treated waste product is removed from the thermal processor 34 by the discharge treatment unit 18. More particularly, a product discharge mechanism 36 removes the treated waste product for storage into a discharge container 38.

Exhaust vapors 40 exit from the thermal processor 34 through dampened exhaust ducts 42.

The exhaust treatment unit 18 receives the exhaust vapors 40, and a heat recuperator 44 may be used to recover heat from the exhaust vapors 40 to preheat air that is introduced into the thermal processor 34. Exhaust vapors 40 may also be treated by a NOx control system 46 and cooled by a water quench system 48 or an air quench system 50 or both. Particulate matter is removed from the exhaust vapors 40 by a particulate control system 52 or a HEPA filtration system 54 or both. Cleaned exhaust gas can then be ejected into the atmosphere through an exhaust stack 56. It is to be understood that each of the systems 44, 46, 48, 50, 52, 54, and 56 and components are well known in the technology and are readily commercially available. Hence, they will not be described in detail herein.

The thermal process equipment including waste LBP particle size reduction equipment, thermal process feed mechanism including screw conveyor or pug mill, extruding equipment, dryer chambers, material feed hoppers and gas treatment systems may all be made mobile and portable and sent to job-site vicinity on rail car, truck and trailer carrier, air carrier or shipboard carrier

The following specific examples are offered by way of illustration and not by way of limitation.

### EXAMPLE 1

Whole wood siding, windows, window frames and other LBP-painted materials were removed from a military barracks and used for testing. The LBP-contaminated materials failed the TCLP test with a test result of 38.9 mg/kg thus classifying the LBP waste as RCRA characteristic hazardous waste. This waste was fed by conveyor into the shredder/grinder mechanism and subsequently introduced into the thermal treatment unit. The LBP waste was continually introduced into the thermal treatment unit at a rate of 81.7 kg/hr for 6 hours. The LBP waste was exposed to a temperature of 816° C. for 20 minutes. During processing, air was allowed to enter the thermal treatment system and was directed at the LBP waste at a velocity and over a wide enough surface area sufficient to facilitate complete oxidation of the carbon present without blowing the waste out of the treatment system.

Treatment of the LBP waste resulted in an approximate volume reduction of 96.35%. Tests showed that the concentration of lead oxide in the treated product ranged from 7.66% to 12.79%. The bulk chemistry of the treated product was evaluated and found to be suitable for recycling. The predominant components of the treated product were oxides of aluminum, calcium, iron, silicon, titanium, sodium, magnesium, zinc and lead. Minor quantities (<1%) of other common non-hazardous oxides were also present. The treated product that was removed from the thermal treatment unit constituted 82% of all of the treated product. The remaining 18% was captured in the exhaust gas treatment system as a fine particulate. The treated product that was removed from the thermal treatment unit exhibited TCLP results ranging from <0.1 to 0.2 mg/kg and thus no longer characterized as a hazardous waste. The particulate material collected from the exhaust gas system exhibited similar chemistry but failed the TCLP test. The treated product from the exhaust gas system exhibited particle sizes ranging from 6.5 μm to <0.6 μm. Less than 1% of the particles were less than 0.6 microns. All of the treated products were found to be suitable for recycling as a lead ore.

### EXAMPLE 2

Wood siding was removed from a military barracks. The wood siding was planed and trimmed to recover the usable wood. The LBP-contaminated planing shavings and trimmings were identified as RCRA characteristic hazardous waste. The shavings and trimming did not require size reduction and were introduced directly into the thermal treatment unit. As in Example 1, careful control of temperature and airflow was exercised. A temperature of 788° C. was initially used with a treatment period of 20 minutes. This treatment scenario did not result in complete oxidation so the temperature was increased to 816° C. with the same treatment period. This resulted in complete oxidation of the LBP waste within the minute time period.

This test reduced the amount of airborne particles entering the exhaust gas treatment system. Only 7% of the treated product became airborne and 93% remained in the thermal treatment unit. The volume of the LBP waste for this example was reduced by 96.97% and the mass of the waste was reduced by 90%. The concentration of lead in the treated product ranged from 21.21% to 26.63%. The primary composition of the treated product was similar to that of example 1 with the notable exception of higher lead concentrations. All of the treated products were found to be suitable for recycling to recover lead.

From the forgoing, it will be appreciated that, although specific embodiments of the invention have been described herein for purposes of illustration, various modification may be made without deviating from the spirit and scope if the invention. Accordingly, the invention is not to be limited except as by the appended claims.

1. A system for recycling of lead from lead-based paint waste, the system comprising:
means for reducing the size of the lead-based paint waste;
a thermal treatment means for oxidizing substantially all of the carbon in the lead-based paint waste to thereby reduce the volume and mass of the lead-based paint waste and form a treated product in which the lead is concentrated;

2. The system of claim 1, further comprising means for treating and
recycling exhaust from the thermal treatment means for use in preheating air for the thermal treatment means.

3. The system of claim 1 wherein the means for thermal treatment heats the lead-based paint waste to a temperature in the range of 500° C. to 1,200° C.

4. The system of claim 1 wherein the reducing size means reduces the size of the lead-based paint waste to a diameter of less than 2 inches.

5. The system of claim 1 wherein the reducing size means reduces the size of the lead-based paint waste to a diameter of less than 1 inch.

6. The system of claim 1, further comprising means for collecting treated lead-based paint waste form the thermal treatment means.

7. The system of claim 1 wherein an oxidizing environment in the thermal treatment means is controlled to prevent the escape of un-oxidized or partially oxidized lead-based paint waste from the thermal treatment means.

8. The system of claim 1 wherein the lead-based paint waste treated by the thermal treatment means has a concentration of lead and reduced waste material that is suitable for recycling of lead contained therein.

9. The system of claim 1 wherein the thermal treatment means subjects the lead-based paint waste to heat treatment for a period of time in the range of 10 minutes to 30 minutes.

10. A process for recycling lead from lead-based paint waste, the process comprising:
reducing the size of the lead-based paint waste;
heating the lead-based paint waste for a predetermined period of time in an oxidizing environment in a predetermined temperature range to oxidize substantially all of the carbon in the lead-based paint waste and to reduce the mass and volume of the lead-based paint waste for concentrating the lead in a remaining treated product.

11. The process of claim 10 comprising controlling the oxidizing environment to prevent the escape of un-oxidized or partially oxidized waste particles from the thermal treatment unit into an off-gas processing system.

12. The process of claim 10 wherein the temperature range is 500° C. to 1,200° C.

13. The process of claim 10 wherein the lead-based paint waste is reduced in particle size to less than 2 inches in diameter prior to heating.

14. The process of claim 10 wherein the particle size of the lead-based paint waste is reduced to less than 1 inch in diameter prior to heating.

15. The process of claim 10 wherein the predetermined period of time is in the range of 10 minutes to 30 minutes.

16. The process of claim 10, further comprising treating and recycling exhaust from the thermal treatment means for use in preheating air for the thermal treatment means.

17. The process of claim 10 wherein the lead-based paint waste is treated by the heating step to have a concentration of lead and reduced waste material that is suitable for recycling of lead contained therein.

18. A system for recycling lead, the system comprising a unit for reducing particle size of lead-based paint waste and an assembly for heating lead-based paint waste to oxidize substantially all of the carbon in the waste and reduce the volume and mass for concentrating the lead in the remaining treated product.

19. A system for recycling of lead from lead-based paint waste, the system comprising:
a unit for reducing the size of the lead-based paint waste;
a thermal treatment unit configured to oxidize substantially all of the carbon in the lead-based paint waste to reduce the volume and mass of the lead-based paint waste and form a treated product in which the lead is concentrated;
a discharge unit for collecting the treated product; and
an exhaust treatment unit for treating and recycling exhaust from the thermal treatment unit for use in preheating air for the thermal treatment unit.

20. The system of claim 19, wherein the thermal treatment unit is configured to subject the lead-based paint waste to a temperature in the range of 500° C. to 1,200° C. for a period of time ranging from 10 minutes to 30 minutes under controlled introduction of oxygen into the thermal treatment unit.
